(19) United States
(12) Patent Application Publication
(10) Pub. No.: US 2025/0104044 A1
(43) Pub. Date: Mar. 27, 2025

(54) CONTACTLESS CHARGING DEVICE AND CONTACTLESS CHARGING METHOD USING THE SAME

(71) Applicant: Korea Railroad Research Institute, Uiwang-si (KR)

(72) Inventors: Jae-Ho KWAK, Uiwang-si (KR); Hyeon-Chyeol HWANG, Uiwang-si (KR); Hee-Gyun JEON, Uiwang-si (KR); Sang-Yup LEE, Uiwang-si (KR); Su-Hyung LEE, Uiwang-si, Gyeonggi-do (KR); Ji-hyeon BAEK, Uiwang-si (KR)

(21) Appl. No.: 18/890,734

(22) Filed: Sep. 19, 2024

(30) Foreign Application Priority Data
Sep. 22, 2023 (KR) 10-2023-0127008

(51) Int. Cl. G06Q 20/32; G06Q 50/40

(52) U.S. Cl. CPC G06Q 20/32; G06Q 50/40; G06Q 2240/00

(57) ABSTRACT

The present disclosure relates to a contactless charging device and a contactless charging method using the same, and particularly, to a location zone-based contactless charging device and a contactless charging method using the same that enable multiple passengers to be charged simultaneously in a one-by-N format without a need for direct tagging of a vehicle terminal, by utilizing a step sensor built into a passenger terminal. The present disclosure may accurately and automatically perform the charging without the terminal tag even when multiple passengers board and alight at the same time, such as in the tram, thereby reducing a boarding and alighting time and providing convenience and safety to the passengers. In addition, the present disclosure may accurately determine the boarding and the alighting of the passenger even when sensing of some beacons installed at multiple stations is uncertain or some beacons are broken, thereby improving reliability and preventing incorrect charging. The present disclosure has advantages of being economical and easy to manage and maintain because all of multiple terminals for the tag in the vehicle are able to be removed and the multiple beacons are not installed unlike in a gate zone-scheme tagless system. Furthermore, the present disclosure has an advantage of increasing the accuracy of the boarding/alighting determination by offsetting uncertainty of short-range communication without an additional cost by utilizing the built-in sensor (the step sensor) of the passenger's smartphone.

### CROSS-REFERENCE TO RELATED APPLICATION

This application claims priority from Korean Patent Application No. 10-2023-0127008 filed on Sep. 22, 2023 in the Korean Intellectual Property Office, and all the benefits accruing therefrom under 35 U.S.C. 119, the contents of which in its entirety are herein incorporated by reference.

### BACKGROUND

### Field

The present disclosure relates to a contactless charging device and a contactless charging method using the same, and particularly, to a location zone-based contactless charging device and a contactless charging method using the same that enable multiple passengers to be charged simultaneously in a one-by-N format without a need for direct tagging of a vehicle terminal, by utilizing a step sensor built into a passenger terminal.

### Description of Related Art

A charging method used in existing public transportation (a bus, a tram, a subway, and the like) is mainly to bring a transportation card or a smartphone equipped with NFC to a terminal and directly tag the same against the terminal. Such method is inconvenient because a user has to take out the transportation card or the smartphone thereof during rush hour, when carrying luggage, or while moving. In addition, such method uses a one-by-one format, which causes a time delay when there is only one boarding gate like the bus, and requires cost and space when installing multiple gates like the subway.

To solve such problem, a contactless (tagless) charging system using a beacon has been developed recently, but because of a nature of short-range communication, it is sensitive to a surrounding environment and has an inaccurate margin of error, so that the one-by-one format of installing multiple beacons and passing through a virtual gate zone is maintained. Therefore, in the case of bus, there is a disadvantage that it is still only applicable to an intercity bus with one entrance and exit door.

### PRIOR ART LITERATURE

### Patent Literature

(Patent Literature 1) Korean Patent Application Publication No. 10-2015-0053655 (published on May 18, 2015)

### SUMMARY

The present disclosure is to provide a contactless charging device and a contactless charging method using the device that enable simultaneous charging of multiple passengers with high reliability.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims and combinations thereof.

A contactless charging device according to the present disclosure includes a vehicle terminal that generates a vehicle signal including a unique vehicle ID, wherein the vehicle terminal is equipped in a vehicle, a station terminal that generates a station signal including a unique station ID, wherein the station terminal is equipped in a station, a passenger terminal that generates a passenger signal including a unique passenger ID and step information that is movement information of a passenger generated from a step sensor, wherein the passenger terminal is carried by the passenger, and a server that determines passenger's boarding of the vehicle and performs payment based on the vehicle signal, the station signal, and the passenger signal.

The server may include a database where the vehicle ID, the station ID, and the passenger ID are stored, and a payment device that determines the passenger's boarding of the vehicle and performs the payment, and the payment device determines that the passenger has boarded the vehicle when the vehicle signal, the first station signal, and the passenger signal are sensed and the step information of the passenger signal indicates that the passenger has boarded, determines that the passenger has not boarded the vehicle when the vehicle signal, the first station signal, and the passenger signal are sensed and the step information of the passenger signal indicates that the passenger is walking, determines that the vehicle has departed from a first station with the passenger on board when the vehicle signal and the passenger signal are sensed and a first station signal is not sensed, determines that the vehicle has arrived at a second station with the passenger on board when the vehicle signal, a second station signal, and the passenger signal are sensed and the step information of the passenger signal indicates that the passenger has boarded, and determines that the passenger has alighted at the second station when the vehicle signal, the second station signal, and the passenger signal are sensed and the step information of the passenger signal indicates that the passenger is walking.

The payment device may determine that the step information indicates that the passenger is walking when the number of steps of the passenger increases in the step information, and determine that the step information indicates that the passenger is boarding when the number of steps of the passenger is maintained at a certain level in the step information.

In addition, a contactless charging method according to the present disclosure includes sensing a vehicle signal including a unique vehicle ID generated from a vehicle terminal, sensing a station signal including a unique station ID generated from a station terminal, sensing a passenger signal including a unique passenger ID generated from a passenger terminal and step information that is movement information of a passenger generated from a step sensor, and determining, by a server, passenger's boarding of the vehicle and performing payment based on the vehicle signal, the station signal, and the passenger signal.

The determining, by the server, of the passenger's boarding of the vehicle and the performing of the payment based on the vehicle signal, the station signal, and the passenger signal may include determining that the passenger has boarded the vehicle when the vehicle signal, the first station signal, and the passenger signal are sensed and the step information of the passenger signal indicates that the passenger has boarded, determining that the passenger has not boarded the vehicle when the vehicle signal, the first station signal, and the passenger signal are sensed and the step information of the passenger signal indicates that the passenger is walking, determining that the vehicle has departed from a first station with the passenger on board when the vehicle signal and the passenger signal are sensed and a first station signal is not sensed, determining that the vehicle has arrived at a second station with the passenger on board when the vehicle signal, a second station signal, and the passenger signal are sensed and the step information of the passenger signal indicates that the passenger has boarded, and determining that the passenger has alighted at the second station when the vehicle signal, the second station signal, and the passenger signal are sensed and the step information of the passenger signal indicates that the passenger is walking.

The server may determine that the step information indicates that the passenger is walking when the number of steps of the passenger increases in the step information, and determine that the step information indicates that the passenger is boarding when the number of steps of the passenger is maintained at a certain level in the step information.

The contactless charging device and the contactless charging method using the same according to the present disclosure may enable the automatic charging of the multiple passengers simultaneously in the one-by-N format without the need for the direct tagging of the vehicle terminal, by utilizing only the beacon and the smartphone built-in sensor, and accordingly, may be applied not only to the tram with multiple entrance and exit doors, but also to the bus and the subway, based on the location zone rather than the one-by-one pass-through gate zone.

In addition, the contactless charging device and the contactless charging method using the same according to the present disclosure may accurately and automatically perform the charging without the terminal tag even when the multiple passengers board and alight at the same time, such as in the tram, thereby not only reducing the boarding and alighting time, but also providing the convenience and the safety to passengers.

In addition, the contactless charging device and the contactless charging method using the same according to the present disclosure may accurately determine the boarding and the alighting of the passenger even when the sensing of some beacons installed in the multiple stations is uncertain or some beacons are broken, thereby improving the reliability and preventing the incorrect charging.

The contactless charging device and the contactless charging method using the same according to the present disclosure are economical and easy to manage and maintain because all of the multiple terminals for the tag in the vehicle are able to be removed and the multiple beacons are not installed unlike in the gate zone-scheme tagless system.

Furthermore, the contactless charging device and the contactless charging method using the same according to the present disclosure may increase the accuracy of the boarding/alighting determination by offsetting the uncertainty of the short-range communication without the additional cost by utilizing the built-in sensor (the step sensor) of the passenger's smartphone.

In addition to the effects described above, specific effects of the present disclosure will be described together while describing specific matters for implementing the invention below.

### BRIEF DESCRIPTION OF DRAWINGS

FIG. 1 is a block diagram of a contactless charging device according to the present disclosure.

FIG. 2 is a conceptual diagram for illustrating step information in a contactless charging device according to the present disclosure.

FIG. 3 is a flowchart of a contactless charging method according to the present disclosure.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

Throughout the present disclosure, unless the context clearly dictates otherwise, each component may be singular or plural.

Hereinafter, it may mean that when a first component is described to be disposed “on (or under)” a second component, the first component may not only be disposed in contact with a top surface (or a bottom surface) of the second component, but also be disposed on the second component with a third component interposed therebetween.

Additionally, it should be understood that when a component is described as being “connected to”, “combined to”, or “coupled to” another component, the components may be directly connected or coupled to each other, but other components may be “interposed” therebetween and the components may be “connected to”, “combined to”, or “connected to” each other via said other components.

As used herein, singular expressions include plural expressions, unless the context clearly dictates otherwise. In the present application, terms such as “composed of” or “include” should not be construed as necessarily including all of various components or steps described herein, and should be interpreted as being able to not including some of the components or the steps and further including additional components or steps.

Throughout the present disclosure, “A and/or B” means A, B, or A and B, unless otherwise specified, and “C to D” means C inclusive to D inclusive unless otherwise specified.

Hereinafter, a preferred embodiment of the present disclosure will be described with reference to the attached drawings.

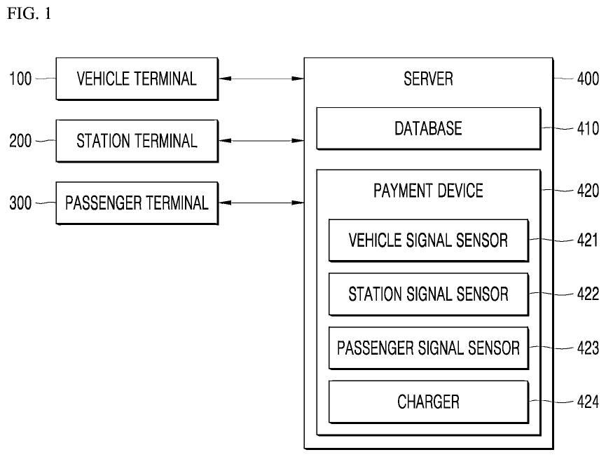

FIG. 1 is a block diagram of a contactless charging device according to the present disclosure.

The contactless charging device according to the present disclosure includes, as shown in FIG. 1, a vehicle terminal 100 equipped in a vehicle, a station terminal 200 equipped in a station, a passenger terminal 300 carried by a passenger, and a server 400.

The vehicle terminal 100 is a terminal installed in the vehicle, such as a tram, a subway, a bus, and the like, that transports passengers. The present embodiment illustrates a beacon installed in the vehicle, that is, a vehicle beacon, as the vehicle terminal 100. The vehicle terminal 100 generates a vehicle signal and outputs the same wirelessly, and the vehicle signal includes a unique vehicle ID and a vehicle beacon signal. The present embodiment illustrates that the vehicle terminal 100 transmits its own vehicle signal to the server 400 via the passenger terminal 300. However, the present disclosure is not limited thereto. The vehicle terminal 100 may receive its own vehicle signal, a station signal of the station terminal 200 to be described later, and a passenger signal of the passenger terminal 300, and transmit the signals to the server 400.

The station terminal 200 is a terminal installed in the station, including a tram station, a subway station, or a bus station. The present embodiment also illustrates a station beacon installed in the station as the station terminal 200. In addition, it is preferable that the station terminal 200 is installed in all stations where the vehicle stops. In the present embodiment, a description is made using two stations, that is, a first station and a second station which is a station following the first station, as an example for convenience of description. In addition, accordingly, it is illustrated that the first station terminal 200 is installed in the first station and the second station terminal 200 is installed in the second station. Such station terminal 200 generates and transmits the station signal, and the station signal includes a station ID and a station beacon signal. In addition, it is illustrated that the station signal generated and output by the station terminal 200 is received by the passenger terminal 300 and transmitted to the server 400. The present disclosure is not limited thereto, and after receiving the vehicle signal, the station terminal 200 may transmit the received vehicle signal and the station signal to the server 400. In addition, the passenger signal may also be received by the station terminal 200 and transmitted to the server 400.

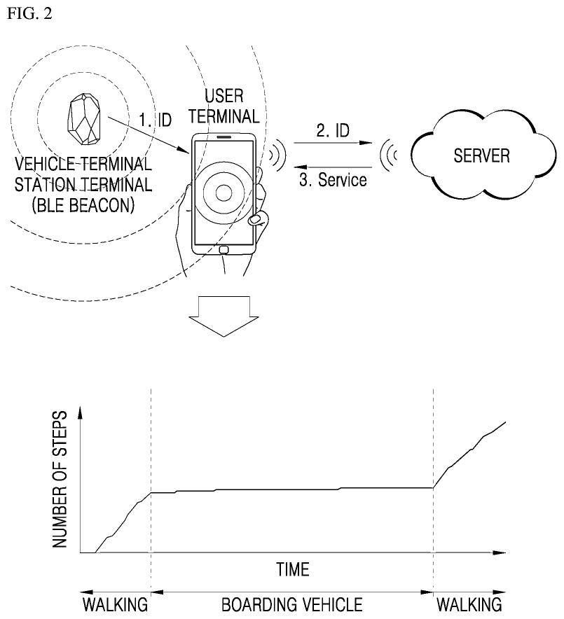

FIG. 2 is a conceptual diagram for illustrating step information in a contactless charging device according to the present disclosure.

The passenger terminal 300 is a terminal carried by the passenger, and is illustrates as a smartphone in the present embodiment. In one example, the present disclosure may not be limited to this, and various terminals including a tablet and a laptop may be used as the passenger terminal 300. However, the present embodiment illustrates the smartphone as the passenger terminal 300 for convenience of description. In addition, the passenger terminal 300 basically has a step sensor built therein. The step sensor generates the step information, and the step information includes information indicating that the passenger is walking, for example, walking information. In addition, the passenger terminal 300 generates and transmits the passenger signal, and includes a passenger ID including a unique character of the passenger and the step information generated from the step sensor.

In one example, the present embodiment illustrates that a payment app of the passenger terminal 300 transmits the passenger signal, the vehicle signal of the vehicle terminal 100, and the station signal of the station terminal 200 to the server 400. Accordingly, the passenger terminal 300 may be installed with an application, that is, the payment app, that is in communication with the vehicle terminal 100 to receive the vehicle signal and receives the station signal of the station terminal 200 to transmit the received signals to the server 400 along with its own passenger signal. In addition, the corresponding application is in communication with the server 400 and performs payment in response to a request of the server 400. In this regard, funds required for the payment may be preloaded in the application or provided via a separately connected card, bank account, or the like.

The server 400 determines whether the passenger is boarding or alighting the vehicle based on the vehicle signal of the vehicle terminal 100, the station signal of the station terminal 200, and the passenger signal of the passenger terminal 300, and performs charging. To this end, the server 400 includes a database 410 and a payment device 420.

The database 410 stores the vehicle ID, the station ID, and the passenger ID. In this regard, the vehicle ID is a unique character assigned to and stored in the vehicle terminal 100 installed in each vehicle, and the station ID is a unique character assigned to and stored in the station terminal 200 installed in each station. In addition, the passenger ID is also the unique character assigned to and stored in each passenger terminal 300.

The payment device 420 performs the payment by determining whether to perform the charging based on the vehicle signal sensed by a vehicle signal sensor 421, the station signal sensed by a station signal sensor 422, and the passenger signal sensed by a passenger signal sensor 423. In addition, to perform the same, the payment device 420 includes the vehicle signal sensor 421, the station signal sensor 422, the passenger signal sensor 423, and a charger 424.

The vehicle signal sensor 421 receives and senses the vehicle signal transmitted from the vehicle terminal 100 or the station terminal 200. In addition, the vehicle signal sensor 421 transmits the received vehicle signal to the charger 424, which will be described later.

The station signal sensor 422 receives and senses the station signal. In this regard, the vehicle terminal 100 may receive the station signal from the station terminal 200 and transmit the same. Alternatively, as described above, when the station terminal 200 senses the vehicle signal, the station terminal 200 may directly transmit the signal to the server 400 by itself. In addition, the station signal received by the station signal sensor 422 is transmitted to the charger 424, which will be described later.

The passenger signal sensor 423 receives and senses the passenger signal transmitted from the passenger terminal 300. In this regard, the passenger signal includes the passenger ID and a step signal generated by the step sensor of the passenger terminal 300, as described above, and the received passenger signal is transmitted to the charger 424. However, when cheating is a concern, it is desirable for the passenger signal to be received by the vehicle terminal 100 and transmitted to the server 400.

The charger 424 determines whether to perform the charging based on the vehicle signal sensed by the vehicle signal sensor 421, the station signal sensed by the station signal sensor 422, and the passenger signal sensed by the passenger signal sensor 423.

First, when determining whether the passenger is boarding the vehicle, the payment device 420 determines that the vehicle is at the first station when the vehicle signal and the first station signal are sensed at the same time, and determines that the passenger is at the first station or has boarded the vehicle when the passenger signal is also sensed. Thereafter, when the vehicle signal is sensed but the first station signal is not sensed, the payment device 420 determines that the vehicle has departed from the first station and is moving to the next station, that is, the second station, and when the passenger signal is uniformly maintained at a certain level in this state, the payment device 420 determines that the passenger has boarded the corresponding vehicle. In one example, when the passenger signal is not sensed or the passenger signal fluctuates by a magnitude equal to or greater than a predetermined magnitude in the state in which the vehicle signal is sensed, but the first station signal is not sensed, it is determined that the corresponding passenger has not boarded the vehicle. In this regard, the payment device 420 withholds the determination for a predetermined amount of time when the passenger signal continues to be sensed even when the passenger signal fluctuates by the magnitude equal to or greater than the predetermined magnitude, and then determines that the passenger has boarded the corresponding vehicle and performs the charging when the passenger signal remains within the predetermined magnitude range. In one example, in this state, when the passenger has not actually boarded the vehicle, the passenger signal will not be sensed when the passenger moves away from the vehicle by a predetermined distance, for example, 70 m or more, so that when the passenger signal fluctuates by the magnitude equal to or greater than the predetermined magnitude, the determination may be withheld for a period of time, for example, 2 minutes, until the vehicle departs from the first station and moves away by the predetermined distance. In addition, when the passenger signal fluctuates by the magnitude equal to or greater than the predetermined magnitude after the vehicle departs from the first station and moves away by the predetermined distance, because the corresponding passenger is continuously moving within the vehicle, it is determined that the corresponding passenger has boarded the vehicle and the charging is performed. That is, when the passenger signal is not constant with the magnitude smaller than or greater than the predetermined magnitude, the payment device 420 determines that the passenger is walking, and when the passenger signal is constant within the predetermined magnitude range, the payment device 420 determines that the passenger is boarding the vehicle and determining whether to perform the charging.

In addition, in sensing the alighting of the passenger, when a second station signal, which is the next station of the first station, is sensed in the state in which the passenger signal is being sensed, the payment device 420 determines that the passenger has moved to the second station. Thereafter, when the passenger signal is not sensed or the passenger signal indicating that the passenger is walking is sensed in the state in which the second station signal is not sensed, it is determined that the corresponding passenger has alighted at the second station.

As described above, the present disclosure may accurately and automatically perform the charging without the terminal tag even when multiple passengers board and alight at the same time, such as in the tram, thereby reducing a boarding and alighting time and providing convenience and safety to the passengers. In addition, the present disclosure may accurately determine the boarding and the alighting of the passenger even when sensing of some beacons installed at multiple stations is uncertain or some beacons are broken, thereby improving reliability and preventing incorrect charging. The present disclosure has advantages of being economical and easy to manage and maintain because all of multiple terminals for the tag in the vehicle are able to be removed and the multiple beacons are not installed unlike in a gate zone-scheme tagless system. Furthermore, the present disclosure has an advantage of increasing the accuracy of the boarding/alighting determination by offsetting uncertainty of short-range communication without an additional cost by utilizing the built-in sensor (the step sensor) of the passenger's smartphone.

Then, a contactless charging method according to the present disclosure will be described with reference to a drawing. Any content that is redundant with the description of the contactless charging device according to the present disclosure described above will be omitted or briefly described.

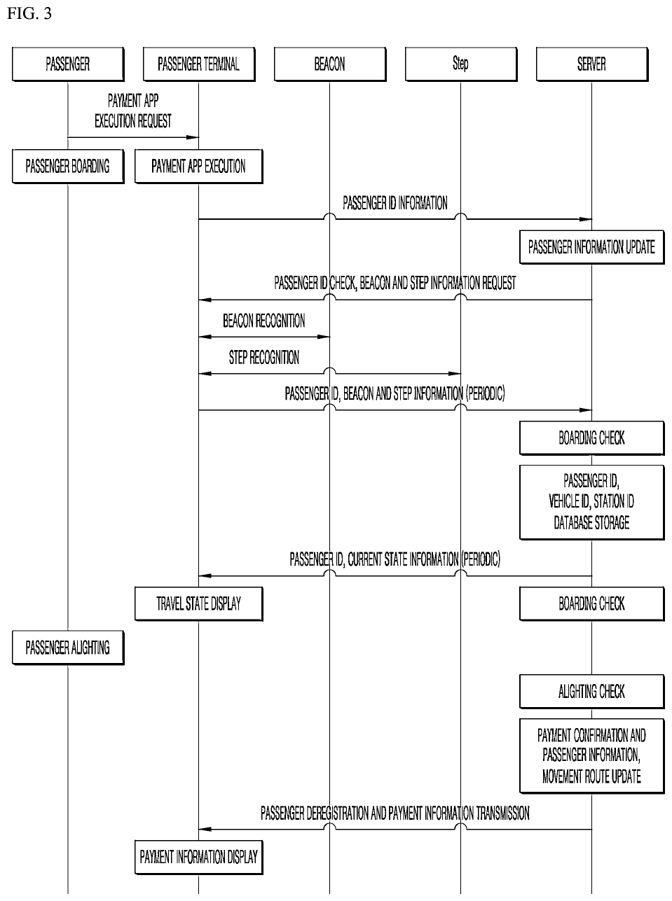

FIG. 3 is a flowchart of a contactless charging method according to the present disclosure.

The contactless charging method according to the present disclosure includes sensing the vehicle signal, sensing the station signal, sensing the passenger signal, and performing the payment, as shown in FIG. 3.

In the sensing of the vehicle signal, the server receives the vehicle signal generated from the vehicle terminal. In this regard, which vehicle the passenger has boarded may be determined based on the vehicle signal.

In the sensing of the station signal, the server receives the station signal generated from the station terminal.

In the sensing of the passenger signal, the server receives the passenger signal generated from the passenger terminal.

In the performing of the payment, the payment is performed by determining whether to charge based on the vehicle signal, the station signal, and the passenger signal. To this end, the performing of the payment includes: determining that the passenger has boarded the vehicle when the vehicle signal, the first station signal, and the passenger signal are sensed and the step information of the passenger signal indicates that the passenger has boarded; determining that the passenger has not boarded the vehicle when the vehicle signal, the first station signal, and the passenger signal are sensed and the step information of the passenger signal indicates that the passenger is walking; determining that the vehicle has departed from the first station with the passenger on board when the vehicle signal and the passenger signal are sensed and the first station signal is not sensed; determining that the vehicle has arrived at the second station with the passenger on board when the vehicle signal, the second station signal, and the passenger signal are sensed and the step information of the passenger signal indicates that the passenger has boarded; and determining that the passenger has alighted at the second station when the vehicle signal, the second station signal, and the passenger signal are sensed and the step information of the passenger signal indicates that the passenger is walking.

It should be understood that the foregoing embodiment is illustrative in all respects and not restrictive, and the scope of the present disclosure will be indicated by the claims which will be described below rather than by the detailed description set forth above. Further, the meaning and scope of the claims which will be described below, as well as all changes and modifications which may be derived from the equivalent concepts thereof, should be interpreted as being included within the scope of the present disclosure.

Although the present disclosure has been described with reference to the accompanying drawings, the present disclosure is not limited by the embodiments disclosed herein and the drawings, and it is obvious that various modifications may be made by those skilled in the art within the scope of the technical idea of the present disclosure. In addition, although the effects based on the configuration of the present disclosure are not explicitly described and illustrated in the description of the embodiment of the present disclosure above, it is natural that predictable effects of the corresponding configuration should also be recognized.

What is claimed is:

1. A contactless charging device comprising:
a vehicle terminal configured to generate a vehicle signal including a unique vehicle ID, wherein the vehicle terminal is equipped in a vehicle;
a station terminal configured to generate a station signal including a unique station ID, wherein the station terminal is equipped in a station;
a passenger terminal configured to generate a passenger signal including a unique passenger ID and step information that is movement information of a passenger generated from a step sensor, wherein the passenger terminal is carried by the passenger; and
a server configured to determine passenger's boarding of the vehicle and perform payment based on the vehicle signal, the station signal, and the passenger signal.

2. The contactless charging device of claim 1, wherein the server includes:
a database where the vehicle ID, the station ID, and the passenger ID are stored; and
a payment device configured to determine the passenger's boarding of the vehicle and perform the payment,
wherein the payment device is configured to:
determine that the passenger has boarded the vehicle when the vehicle signal, the first station signal, and the passenger signal are sensed and the step information of the passenger signal indicates that the passenger has boarded;
determine that the passenger has not boarded the vehicle when the vehicle signal, the first station signal, and the passenger signal are sensed and the step information of the passenger signal indicates that the passenger is walking;
determine that the vehicle has departed from a first station with the passenger on board when the vehicle signal and the passenger signal are sensed and a first station signal is not sensed;
determine that the vehicle has arrived at a second station with the passenger on board when the vehicle signal, a second station signal, and the passenger signal are sensed and the step information of the passenger signal indicates that the passenger has boarded; and
determine that the passenger has alighted at the second station when the vehicle signal, the second station signal, and the passenger signal are sensed and the step information of the passenger signal indicates that the passenger is walking.

3. The contactless charging device of claim 2, wherein the payment device is configured to:
determine that the step information indicates that the passenger is walking when the number of steps of the passenger increases in the step information; and
determine that the step information indicates that the passenger is boarding when the number of steps of the passenger is maintained at a certain level in the step information.

4. A contactless charging method comprising:
sensing a vehicle signal including a unique vehicle ID generated from a vehicle terminal;
sensing a station signal including a unique station ID generated from a station terminal;
sensing a passenger signal including a unique passenger ID generated from a passenger terminal and step information that is movement information of a passenger generated from a step sensor; and
determining, by a server, passenger's boarding of the vehicle and performing payment based on the vehicle signal, the station signal, and the passenger signal.

5. The contactless charging method of claim 4, wherein the determining, by the server, of the passenger's boarding of the vehicle and the performing of the payment based on the vehicle signal, the station signal, and the passenger signal includes:
determining that the passenger has boarded the vehicle when the vehicle signal, the first station signal, and the passenger signal are sensed and the step information of the passenger signal indicates that the passenger has boarded;
determining that the passenger has not boarded the vehicle when the vehicle signal, the first station signal, and the passenger signal are sensed and the step information of the passenger signal indicates that the passenger is walking;
determining that the vehicle has departed from a first station with the passenger on board when the vehicle signal and the passenger signal are sensed and a first station signal is not sensed;
determining that the vehicle has arrived at a second station with the passenger on board when the vehicle signal, a second station signal, and the passenger signal are sensed and the step information of the passenger signal indicates that the passenger has boarded; and
determining that the passenger has alighted at the second station when the vehicle signal, the second station signal, and the passenger signal are sensed and the step information of the passenger signal indicates that the passenger is walking.

6. The contactless charging method of claim 5, wherein the server is configured to:
determine that the step information indicates that the passenger is walking when the number of steps of the passenger increases in the step information; and
determine that the step information indicates that the passenger is boarding when the number of steps of the passenger is maintained at a certain level in the step information.
